(19) United States
(12) Patent Application Publication
(10) Pub. No.: US 2026/0149381 A1
(43) Pub. Date: May 28, 2026

(54) HIGH-POWER POWER CONVERSION DEVICE

(71) Applicant: MetaPWR Electronics Co., Ltd., Shanghai (CN)

(72) Inventors: Da Jin, Shanghai (CN); Yahong Xiong, Shanghai (CN)

(73) Assignee: MetaPWR Electronics Co., Ltd., Shanghai (CN)

(21) Appl. No.: 19/399,651

(22) Filed: Nov. 25, 2025

(30) Foreign Application Priority Data
Nov. 25, 2024 (CN) 202411695465.3

(51) Int. Cl. H02M 3/335; H01F 27/24; H01F 27/29; H02M 1/088; H02M 3/00

(52) U.S. Cl. CPC H02M 3/33576; H01F 27/24; H01F 27/29; H02M 1/088; H02M 3/003

(57) ABSTRACT

A high-power power conversion device includes: a first high-voltage sub-circuit, a second high-voltage sub-circuit, a first low-voltage sub-circuit, a second low-voltage sub-circuit, an input positive terminal, an input negative terminal, an output positive terminal, and an output negative terminal. Under the condition that high-power output is met, the volume and loss of the high-power power conversion device are further reduced, and a steady-state performance and a dynamic performance of the high-power power conversion device are improved. A voltage equalization control scheme is also provided to achieve voltage equalization between the two high-voltage sub-circuits.

### CROSS-REFERENCE TO RELATED APPLICATION

This application claims the priority benefit of China application serial no. 202411695465.3 filed on Nov. 25, 2024. The entirety of the above-mentioned patent application is hereby incorporated by reference herein and made a part of this specification.

### BACKGROUND

### Description of Related Art

With the development of artificial intelligence, the power requirements of intelligent data processing chips, such as GPU/CPU/NPU, etc., (collectively, XPU) are getting higher and higher, so that the power of the server is increased, the input voltage of the server gradually rises from 12V to 48V, and even rises to 380V and 800V. Therefore, the ratio of the input voltage to the output voltage is higher and higher. In order to obtain a high ratio of input voltage to output voltage and high-power application, there is an urgent need for a circuit architecture with high conversion efficiency and a conversion device.

According to the solution of the high ratio of the input voltage to the output voltage of the power conversion device, a high-voltage half-bridge input unit is used to be connected in series, so as to reduce the input voltage of each high-voltage half-bridge input unit, thereby reducing the switching loss of the power switching device in each high-voltage half-bridge input unit under high-frequency switching, and improving the conversion efficiency of the overall power conversion device; the high-voltage half-bridge input unit is connected in series, reduces the voltage difference of the maximum voltage and the minimum voltage of the transformer, and can obtain better EMI characteristics. On the other hand, the low-voltage full-bridge rectifier output unit is connected in parallel to meet the high-power requirements of the conversion device.

### SUMMARY

In view of the above, one of the objectives of the application is to provide a high-power power conversion device, comprising:
a first high-voltage sub-circuit, a second high-voltage sub-circuit, a first low-voltage sub-circuit, a second low-voltage sub-circuit, an input positive terminal, an input negative terminal, an output positive terminal, and an output negative terminal,
wherein the first high-voltage sub-circuit and the second high-voltage sub-circuit are electrically connected in series between the input positive terminal and the input negative terminal, and the first low-voltage sub-circuit and the second low-voltage sub-circuit are electrically connected in parallel between the output positive terminal and the output negative terminal;
each of the first high-voltage sub-circuit and the second high-voltage sub-circuit comprises a high-voltage winding, each of the first low-voltage sub-circuit and the second low-voltage sub-circuit comprises a low-voltage winding, and the high-voltage winding and the low-voltage winding are wound on the same magnetic core;
the magnetic core comprises a first side and a third side opposite to each other, and a second side and a fourth side opposite to each other;
each of the first high-voltage sub-circuit and the second high-voltage sub-circuit comprises a plurality of high-voltage switches, and the plurality of high-voltage switches are arranged adjacent to the first side of the magnetic core; each of the first low-voltage sub-circuit and the second low-voltage sub-circuit comprises a plurality of lower switches, and the plurality of lower switches are arranged along the third side of the magnetic core.

Preferably, a first end and a second end of the low-voltage winding are both disposed adjacent to the third side of the magnetic core.

Preferably, the first high-voltage sub-circuit is connected between the input positive terminal and an input middle terminal, and the second high-voltage sub-circuit is connected between the input middle terminal and the input negative terminal; and a first terminal and a second terminal of the high-voltage winding are both adjacent to the first side of the magnetic core.

Preferably, the second end of each high-voltage winding and the second end of each low-voltage winding have the same polarity.

Preferably, the magnetic core comprises an upper magnetic cover, a lower magnetic cover and a plurality of magnetic columns, and the plurality of magnetic columns are arranged between the upper magnetic cover and the lower magnetic cover; the plurality of magnetic columns comprise a first side column, a second side column, a middle column, a first winding column, and a second winding column; the first side column, the first winding column, the middle column, the second winding column, and the second side column are arranged in the same direction in sequence.

Preferably, the low-voltage winding of the first low-voltage sub-circuit is wound at least one circle around the first winding column from the first end to the second end in a first direction; and the low-voltage winding of the second low-voltage sub-circuit is wound at least one circle around the second winding column from the first end to the second end in the first direction.

Preferably, the high-voltage winding of the first high-voltage sub-circuit is wound at least two circles around the first winding column from the first end to the second end in a first direction, and the high-voltage winding of the second high-voltage sub-circuit is wound at least two circles around the second winding column from the first end to the second end around the second winding column in the first direction.

Preferably, the high-power power conversion device, further comprising a substrate, wherein the substrate comprises an upper surface and a lower surface opposite to each other, and the substrate further comprises a plurality of wiring layers; the high-voltage winding of the first high-voltage sub-circuit from the first end to the second end is first wound at least two circles around the first winding column in the first direction on a first wiring layer, and then reaches to a second wiring layer by means of a first via and is wound at least two circles around the first winding column in the first direction on the second wiring layer; the high-voltage winding of the second high-voltage sub-circuit from the first end to the second end is first wound at least two circles around the second winding column in the first direction on the first wiring layer, and then reaches to the second layer by means of a second via and is wound at least two circles around the second winding column in the first direction on the second layer.

Preferably, the plurality of lower switches of each low-voltage sub-circuit comprise a first lower switch, a second lower switch, a third lower switch, and a fourth lower switch; the first lower switch and the second lower switch are electrically connected in series to a first lower node, and are connected in series between the output positive terminal and the output negative terminal; the third lower switch and the fourth lower switch are electrically connected in series to a second lower node, and are connected in series between the output positive terminal and the output negative terminal; a first end of the low-voltage winding is electrically connected to the first lower node, and a second end of the low-voltage winding is electrically connected to the second lower node.

Preferably, each of the first high-voltage sub-circuit and the second high-voltage sub-circuit comprises a switch bridge arm and a capacitor bridge arm electrically connected in parallel; the switch bridge arm is formed by electrically connecting a plurality of high-voltage switches in series, the plurality of high-voltage switches are an upper switch and a middle switch respectively, and the upper switch and the middle switch are electrically connected to a first upper node; the capacitor bridge arm comprises an upper capacitor and a middle capacitor electrically connected in series, and the upper capacitor and the middle capacitor are electrically connected in series to a second upper node; two ends of the high-voltage winding are connected across the first upper node and the second upper node of the same high-voltage sub-circuit.

Preferably, the high-power power conversion device, further comprising an output capacitor and an output terminal, wherein the output capacitor and the output terminal are arranged adjacent to the lower switch; the lower switches in each of the low-voltage sub-circuits are sequentially arranged along the third side of the magnetic core according to a sequence of the first lower switch, the second lower switch, the fourth lower switch, and the third lower switch.

Preferably, the high-power power conversion device, further comprising a substrate, wherein the substrate comprises an upper surface and a lower surface opposite to each other, at least part of the lower switches and/or at least part of the output capacitors are arranged on the upper surface, and the output terminal is arranged on the lower surface.

Preferably, the high-power power conversion device, further comprising a substrate, a metal block, and an input terminal, wherein the substrate comprises an upper surface and a lower surface opposite to each other, the metal block and the high-voltage switch are respectively correspondingly arranged on the upper surface and the lower surface, the input terminal is arranged adjacent to the high-voltage switch, and the upper capacitor and the middle capacitor are arranged between the high-voltage switch and the magnetic core.

Preferably, the first high-voltage sub-circuit comprises a first upper switch and a first middle switch, the second high-voltage sub-circuit comprises a second upper switch and a second middle switch, and each of the first low-voltage sub-circuit and the second low-voltage sub-circuit comprises a first lower switch, a second lower switch, a third lower switch, and a fourth lower switch;
the high-power power conversion device further comprises a first control signal PWM1, a second control signal PWM2, a third control signal PWM3, a fourth control signal PWM4, a fifth control signal PWM5, a sixth control signal PWM6, a seventh control signal PWM7, and an eighth control signal PWM8;
the first upper switch is controlled by the first control signal PWM1, the first middle switch is controlled by the third control signal PWM3, the second upper switch is controlled by the second control signal PWM2, the second middle switch is controlled by the fourth control signal PWM4, and the first control signal PWM1, the second control signal PWM2, the third control signal PWM3, and the fourth control signal PWM4 are sequentially staggered by 90°;
the second lower switch and the third lower switch of the first low-voltage sub-circuit are controlled by the fifth control signal PWM5, the first lower switch and the fourth lower switch of the first low-voltage sub-circuit are controlled by the sixth control signal PWM6, the second lower switch and the third lower switch of the second low-voltage sub-circuit are controlled by the seventh control signal PWM7, the first lower switch and the fourth lower switch of the second low-voltage sub-circuit are controlled by the eighth control signal PWM8, the fifth control signal PWM5 is complementary to the first control signal PWM1, the sixth control signal PWM6 is complementary to the third control signal PWM3, the seventh control signal PWM7 is complementary to the second control signal PWM2, and the eighth control signal PWM8 is complementary to the fourth control signal PWM4.

Preferably, the high-power power conversion device, further comprising a controller configured to perform voltage equalization control on input voltages of the first high-voltage sub-circuit and the second high-voltage sub-circuit.

Preferably, the high-power power conversion device, further comprising a first voltage detection circuit, a second voltage detection circuit, a first drive circuit, and a second drive circuit, wherein the first voltage detection circuit and the second voltage detection circuit are connected to an input end of the controller, and the first drive circuit and the second drive circuit are connected to an output end of the controller;
the first voltage detection circuit is configured to detect a voltage between the input positive terminal and the input middle terminal, the second voltage detection circuit is configured to detect a voltage between the input middle terminal and the input negative terminal, the first drive circuit is configured to drive the high-voltage switch of the high-voltage sub-circuit, and the second drive circuit is configured to drive the lower switch of the low-voltage sub-circuit.

Preferably, the controller adjusts a turn-on period of the high-voltage switch of the first high-voltage sub-circuit or a turn-on period of the high-voltage switch of the second high-voltage sub-circuit according to an output of the first voltage detection circuit and an output of the second voltage detection circuit, so as to achieve voltage equalization control.

Preferably, the controller adjusts a switching frequency of the high-voltage switch of the first high-voltage sub-circuit or a switching frequency of the high-voltage switch of the second high-voltage sub-circuit according to an output of the first voltage detection circuit and the second voltage detection circuit, so as to achieve voltage equalization control.

A voltage equalization control circuit for a power conversion device, wherein the power conversion device comprises:
a first high-voltage sub-circuit, a second high-voltage sub-circuit, an input positive terminal, an input negative terminal, an input middle terminal, a low-voltage circuit, and a magnetic component, wherein the first high-voltage circuit, the second high-voltage circuit, and the low-voltage circuit are coupling and transmitting energy by means of the magnetic component;
the voltage equalization control circuit comprises a first voltage detection circuit, a second voltage detection circuit and a controller, wherein the first high-voltage sub-circuit and the second high-voltage sub-circuit are electrically connected in series between the input positive terminal and the input negative terminal, the first high-voltage sub-circuit is connected across the input positive terminal and the input middle terminal, and the second high-voltage sub-circuit is connected across the input middle terminal and the input negative terminal;
the first voltage detection circuit and the second voltage detection circuit are connected to an input end of the controller, the first voltage detection circuit is used for detecting the voltage between the input positive terminal and the input middle terminal, and the second voltage detection circuit is used for detecting the voltage between the input middle terminal and the input negative terminal;
the first high-voltage sub-circuit and the second high-voltage sub-circuit both comprise a plurality of switches, and the controller is used for performing voltage equalization control on the input voltages of the first high-voltage sub-circuit and the input voltage of the second high-voltage sub-circuit.

Preferably, the controller adjusts the on-time of the switch of the first high-voltage sub-circuit or the on-time of the switch of the second high-voltage sub-circuit according to the output of the first voltage detection circuit and the output of the second voltage detection circuit, so as to achieve voltage equalization control.

Preferably, the controller adjusts a switching frequency of the switch of the first high-voltage sub-circuit or a switching frequency of the switch of the second high-voltage sub-circuit according to an output of the first voltage detection circuit and the second voltage detection circuit, so as to achieve voltage equalization control.

A voltage equalization control method for a power conversion device, wherein the power conversion device comprises a first high-voltage sub-circuit, a second high-voltage sub-circuit, an input positive terminal, an input negative terminal, an input middle terminal, a low-voltage circuit, and a magnetic component, wherein the first high-voltage sub-circuit and the second high-voltage sub-circuit and the low-voltage circuit are coupling and transmitting energy by means of a magnetic component; the first high-voltage sub-circuit and the second high-voltage sub-circuit are electrically connected in series between the input positive terminal and the input negative terminal, the first high-voltage sub-circuit is connected across the input positive terminal and the input middle terminal, and the second high-voltage sub-circuit is connected across the input middle terminal and the input negative terminal; the first high-voltage sub-circuit and the second high-voltage sub-circuit both comprise a plurality of switches;
wherein the voltage equalization control method for the power conversion device comprises:
detecting an input voltage of the first high-voltage circuit and an input voltage of the second high-voltage circuit: and
adjusting a turn-on period or a switching frequency of the switch of the first high-voltage sub-circuit and/or the second high-voltage sub-circuit, so as to achieve voltage equalization control of input voltages of the first high-voltage circuit and the second high-voltage circuit.

Compared with the prior art, the application has the following beneficial effects:
(1) The circuit topology of the present application is suitable for high-power conversion devices, and the circuit topology achieves high-power output and reduces switching loss in high-voltage circuit by means of connecting the high-voltage circuits in series, and connecting the low-voltage circuits in parallel.
(2) The device layout arrangement of the power conversion device and the winding manner of the transformer of the present application reduce the loss and volume of the high-power conversion device, and improve the steady-state performance and dynamic performance of the conversion device.
(3) The control circuit of the present application can realize voltage equalization control of a high-voltage sub-circuit connected in series, thereby improving the stability and safety of the conversion device.

### BRIEF DESCRIPTION OF THE DRAWINGS

FIG. 1 is a schematic diagram of a circuit topology of a high-power conversion device according to the present application.

FIG. 2 is a PWM control timing diagram of FIG. 1.

FIG. 3A to FIG. 3B are winding manners of a transformer winding according to the present application.

FIG. 4A to FIG. 4C are schematic structural layout diagrams of a high-power conversion device according to the present application.

FIG. 5 is a control block diagram of a voltage equalization circuit of a high-power conversion device according to the present application.

### DESCRIPTION OF THE EMBODIMENTS

One of the cores of the present application is to provide a circuit topology, which is suitable for a high-power conversion device; a circuit topology and a control method are provided, the circuit topology has low switching loss and high conversion efficiency in the case of high-frequency switching of the power switch. The present application further provides a power conversion device using the circuit topology, which provides a device layout setting of the power conversion device and a winding mode of the transformer. Under the condition that high-power output is met, the volume and loss of the power conversion device are further reduced, and the steady-state performance and dynamic performance of the conversion device are improved.

Technical solutions in the embodiments of the present disclosure will be clearly and completely described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

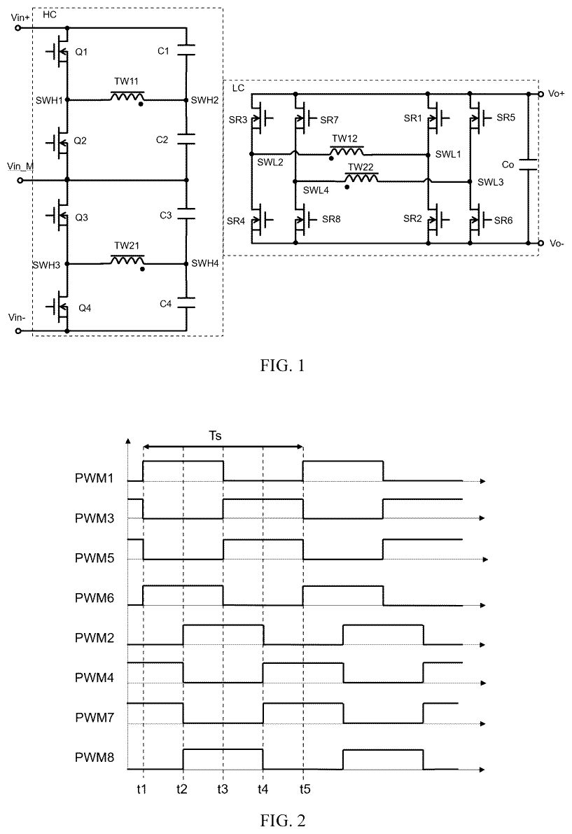

The present application adopts a circuit topology as shown in FIG. 1, comprising a high-voltage circuit HC and a low-voltage circuit LC, wherein the high-voltage circuit HC comprises a first high-voltage sub-circuit and a second high-voltage sub-circuit, and each high-voltage sub-circuit comprises a switch bridge arm, a capacitor bridge arm and a high-voltage winding; the first high-voltage sub-circuit is connected between an input positive terminal Vin+ and an input middle terminal VinM, and the second high-voltage sub-circuit is connected across the input middle terminal VinM and an input negative terminal Vin−. The first high-voltage sub-circuit comprises a first switch bridge arm and a first capacitor bridge arm connected in parallel, the first switch bridge arm comprises a first upper switch Q1 and a first middle switch Q2, the first upper switch Q1 is connected across the input positive terminal Vin+ and a first upper node SWH1, and the first middle switch Q2 is connected between the first upper node SWH1 and the input middle terminal VinM; the first capacitor bridge arm comprises an upper capacitor C1 and a middle capacitor C2, wherein the upper capacitor C1 and the middle capacitor C2 are electrically connected in series to a second upper node SWH2; the first high-voltage winding TW11 is connected between the first upper node SWH1 and the second upper node SWH2; a first end of the first high-voltage winding TW11 is short-circuited to the first upper node SWH1; and a second end of the first high-voltage winding TW11 is shorted to the second upper node SWH2. The second high-voltage sub-circuit comprises a second switch bridge arm and a second capacitor bridge arm connected in parallel, the second switch bridge arm comprises a second upper switch Q3 and a second middle switch Q4, the second upper switch Q3 and the second middle switch Q4 are electrically connected in series to a first upper node SWH3, the second upper switch Q3 is connected across the input middle terminal VinM and the first upper node SWH3, and the second middle switch Q4 is connected between the first upper node SWH3 and the input negative terminal Vin−; the second capacitor bridge arm comprises an upper capacitor C3 and a middle capacitor C4, wherein the upper capacitor C3 and the middle capacitor C4 are electrically connected in series to a second upper node SWH4; the second high-voltage winding TW21 is connected between the first upper node SWH3 and the second upper node SWH4; a first end of the second high-voltage winding TW21 is short-circuited to the first upper node SWH3; and a second end of the second high-voltage winding TW11 is shorted to the second upper node SWH4.

The low-voltage circuit LC comprises a first low-voltage sub-circuits and a second low-voltage sub-circuit electrically connected in parallel. Each low-voltage sub-circuit uses a full-bridge rectifier circuit, and is electrically connected in parallel and then connected across an output positive terminal Vo+ and an output negative terminal Vo−. The first low-voltage sub-circuit comprises a first lower switch SR1, a second lower switch SR2, a third lower switch SR3, a fourth lower switch SR4, and a low-voltage winding TW12; the first lower switch SR1 and the second lower switch SR2 are electrically connected in series to a first lower node SWL1, the third lower switch SR3, and the fourth lower switch SR4 are electrically connected in series to a second lower node SWL2; the low-voltage winding TW12 is connected between the first lower node SWL1 and the second lower node SWL2; a first end of the low-voltage winding TW12 is short-circuited to the first lower node SWL1, and a second end of the low-voltage winding TW12 is shorted to the second lower node SWL2. The second low-voltage sub-circuit comprises a first lower switch SR5, a second lower switch SR6, a third lower switch SR7, a fourth lower switch SR8, and a low-voltage winding TW22; the first lower switch SR5 and the second lower switch SR6 are electrically connected in series to a first lower node SWL3, the third lower switch SR7 and the fourth lower switch SR8 are electrically connected in series to a second lower node SWL4, and the low-voltage winding TW22 is connected between the first lower node SWL3 and the second lower node SWL4; a first end of the low-voltage winding TW22 is short-circuited to the first lower node SWL3, and a second end of the low-voltage winding TW22 is short-circuited to the second lower node SWL4. The low-voltage circuit LC further comprises an output capacitor Co, and the output capacitor Co is connected across the output positive terminal Vo+ and the output negative terminal Vo−. In the present embodiment, the first high-voltage winding TW11 and the low-voltage winding TW12 are coupled to form a transformer, and the second end of the first high-voltage winding TW11 and the second end of the low-voltage winding TW12 have the same polarity, and are marked by the symbol “•”; the second high-voltage winding TW21 is coupled to the low-voltage winding TW22 to form a transformer, and the second end of the second high-voltage winding TW21 and the second end of the low-voltage winding TW22 have the same polarity, and are also labeled with the symbol “•”.

The control timing as shown in FIG. 2 is applicable to the circuit topology shown in FIG. 1, and comprises eight control signals, which are respectively a first control signal PWM1, a second control signal PWM2, a third control signal PWM3, a fourth control signal PWM4, a fifth control signal PWM5, a sixth control signal PWM6, a seventh control signal PWM7, and an eighth control signal PWM8, wherein the first control signal PWM1, the second control signal PWM2, the third control signal PWM3, and the fourth control signal PWM4 are sequentially staggered by 90 degrees, which respectively used for controlling the turn-on and turn-off of the first upper switch Q1, the second upper switch Q3, the first middle switch Q2, and the second middle switch Q4. Ignoring the dead time between the control signals, the fifth control signal PWM5 is complementary to the first control signal PWM1 and used for controlling the turn-on and turn-off of the second lower switch SR2 and the third lower switch SR3; the sixth control signal PWM6 is complementary to the third control signal PWM3 and is used for controlling the turn-on and turn-off of the first lower switch SR1 and the fourth lower switch SR4; the seventh control signal PWM7 is complementary to the second control signal PWM2, and is used for controlling the turn-on and turn-off of the second lower switch SR6 and the third lower switch SR7; and the eighth control signal PWM8 is complementary to the fourth control signal PWM4 and is used for controlling the turn-on and turn-off of the first lower switch SR5 and the fourth lower switch SR8.

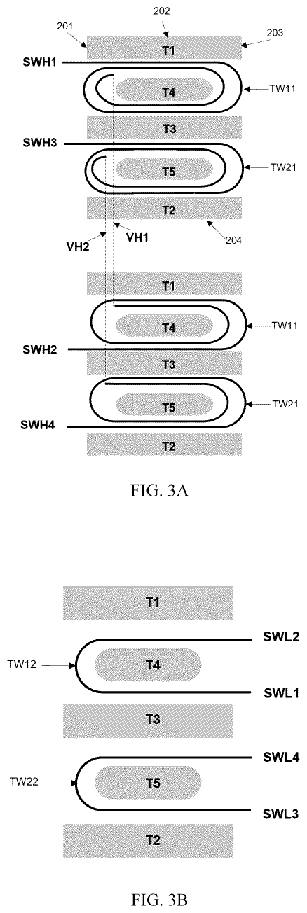

A winding manner and a magnetic core structure of the high-voltage winding and the low-voltage winding are also disclosed, as shown in FIG. 3A and FIG. 3B. The high-power conversion device further comprises a substrate 10, wherein the substrate 10 comprises a plurality of wiring layers, and the high-voltage winding and the low-voltage winding are implemented by means of the wiring layers. The magnetic core 200 comprises a first side 201 and a third side 203 opposite to each other, a second side 202 and a fourth side 204 opposite to each other, a first side column T1, a second side column T2, a middle column T3, a first winding column T4 and a second winding column T5; the first side column T1, the first winding column T4, the middle column T3, the second winding column T5 and the second side column T2 are sequentially arranged in the same direction; the first side column T1 is arranged adjacent to the second side 202 of the magnetic core 200; and the second side column T2 is arranged adjacent to the fourth side 204 of the magnetic core 200. The magnetic core 200 is assembled to the wiring layers, and cooperates with the high-voltage winding and the low-voltage winding to form a transformer. The first end and the second end of the high-voltage winding are arranged adjacent to the first side 201 of the magnetic core; furthermore, the first end and the second end of the high-voltage winding are arranged on different wiring layers. As shown in FIG. 3A, the first high-voltage winding TW11 from the first end (SWH1) to the second end (SWH2) is wound around the first winding column T4 at least two circles in a clockwise direction (i.e. a first direction)on a first wiring layer, and then reaches to a second wiring layer by means of a first via VH1 and is wound at least two circles around the first winding column T4 in a clockwise direction on the second wiring layer. The second high-voltage winding TW21 from the first end (SWH3) to the second end (SWH4) is wound at least two circles around the second winding column T5 in a clockwise direction on the first wiring layer, and then reaches to the second wiring layer by means of a second via VH2 and is wound at least two circles in a clockwise direction around the second winding column T5 on the second wiring layer.

As shown in FIG. 3B, both the first end and the second end of the low-voltage winding are disposed adjacent to the third side 203 of the magnetic core. In a third layer, the low-voltage winding TW12 is wound around the first winding column T4 in a clockwise direction from the first end (SWL1) to the second end (SWL2); the low-voltage winding TW22 is wound around the second winding column T5 in a clockwise direction from the first end (SWL3) to the second end (SWL4).

The first layer, the second layer, and the third layer herein only represent different wiring layers, and do not represent the arrangement order of the wiring layers. A preferred arrangement sequence of the wiring layers is that the first layer, the third layer, and the second layer are sequentially arranged from top to bottom, so that the high-voltage winding and the low-voltage winding satisfy a staggered arrangement. In addition, the winding of the high-voltage winding is not limited to two wiring layers, it may be disposed on more wiring layers, and are also electrically connected in series by means of vias, thereby increasing the number of winding turns of the high-voltage winding, and further increasing the ratio of the input voltage to the output voltage of the high-power conversion device. The winding of the low-voltage winding can also be arranged on more wiring layers, and each layer is electrically connected in parallel by means of the vias, thereby reducing the winding impedance on the low-voltage winding and reducing the loss on the winding. In addition, the winding in a clockwise direction herein is merely an example, it may be wound in a counterclockwise direction.

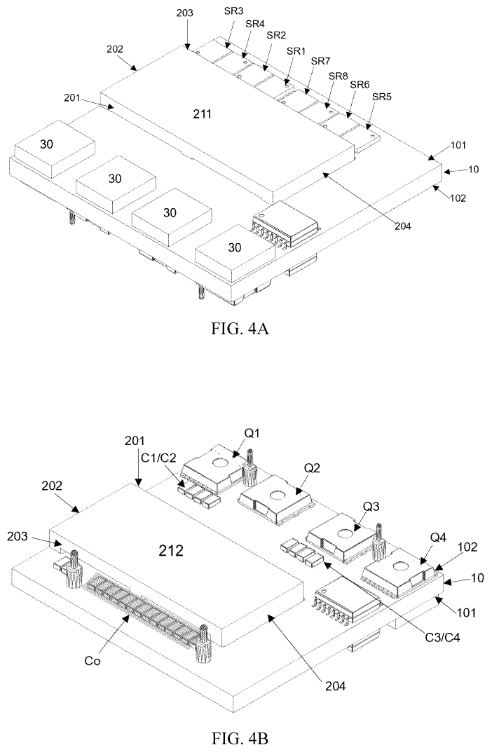

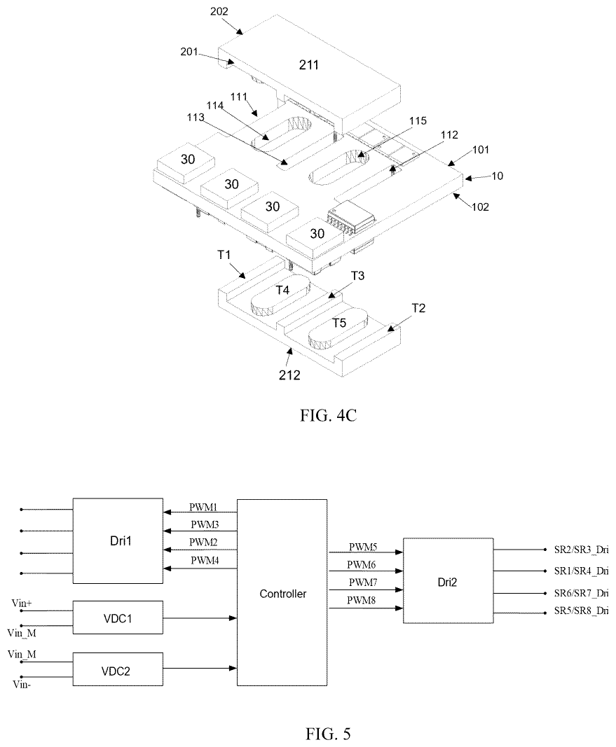

FIG. 4A to FIG. 4C show a structural layout of the high-power conversion device. FIG. 4A is a schematic top view of the high-power conversion device, FIG. 4B is a schematic bottom view of the high-power conversion device, and FIG. 4C is an exploded schematic diagram of the high-power conversion device. With reference to FIG. 4A to 4C, the substrate 10 comprises an upper surface 101 and a lower surface 102 opposite to each other, holes 112, 113, 114 and 115 and a hole groove 111; wherein the hole grooves 111 and the holes 112, 113, 114 and 115 penetrate through the upper surface 101 and the lower surface 102, and are respectively supplied to the first side column T1, the second side column T2, the middle column T3, the first winding column T4 and the second winding column T5 to pass though; the magnetic column, the upper magnetic cover 211 and the lower magnetic cover 212 are assembled to the substrate together, and form a magnetic component with the high-voltage winding and the low-voltage winding in the substrate.

As shown in FIG. 4A, the lower switches SR1-SR8 are disposed on the upper surface 101 of the substrate 10 and are disposed adjacent to the third side 203 of the magnetic core 20, i.e. adjacent to the first and second ends of the low-voltage windings. In detail, the first lower switch SR1 and the second lower switch SR2 are disposed adjacent to the first end of the low-voltage winding TW12, and the third lower switch SR3 and the fourth lower switch SR4 are disposed adjacent to the second end of the low-voltage winding TW12; and the source electrode of the second lower switch SR2 is adjacent to the source electrode of the fourth lower switch SR4; so that the first lower switch SR1, the second lower switch SR2, the fourth lower switch SR4, and the third lower switch SR3 are sequentially arranged in a line and close to the third side 203 of the magnetic core. The first lower switch SR5 and the second lower switch SR6 are arranged adjacent to the first end of the low-voltage winding TW22, and the third lower switch SR7 and the fourth lower switch SR8 are arranged adjacent to the second end of the low-voltage winding TW22; and the source electrode of the second lower switch SR6 is adjacent to the source electrode of the fourth lower switch SR8; so that the first lower switch SR5, the second lower switch SR6, the fourth lower switch SR8, and the third lower switch SR7 are sequentially arranged in a line and close to the third side 203 of the magnetic core 20. And in other embodiments, some or all of the lower switches are disposed on the lower surface 102 of the substrate 10, as long as the connection distance between the lower switch and the low-voltage winding may be as short as possible just like described above, thereby reducing the loss of the low-voltage circuit.

As shown in FIG. 4B, the first upper switch Q1, the second upper switch Q3, the first middle switch Q2, and the second middle switch Q4 are disposed adjacent to the first side 201 of the magnetic core 20; the first capacitor bridge arm, i.e. the upper capacitor C1 and the middle capacitor C2, are disposed between the first switch bridge arm and the magnetic core; and the second capacitor bridge arm, i.e. the upper capacitor C3 and the middle capacitor C4, are disposed between the second switch bridge arm and the magnetic core 20. The switch and the capacitor in the first high-voltage sub-circuit are arranged adjacent to the first end and the second end of the first high-voltage winding TW11; and the switch and the capacitor in the second high-voltage sub-circuit are arranged adjacent to the first end and the second end of the second high-voltage winding TW21. On the upper surface 101 of the substrate 10, at the corresponding positions of the first upper switch Q1, the second upper switch Q3, the first middle switch Q2 and the second middle switch Q4 are respectively provided with metal blocks 30, and the metal blocks 30 are respectively connected to the heat dissipation pins of the upper switches or the middle switches by means of through holes, so that the temperature of the upper switches or the middle switches are conducted to the metal blocks 30. Further, a heat transfer pad and a heat sink are placed on the metal blocks, so that the temperature of the metal block 30 can be reduced, thereby reducing the temperature of the upper switches or the middle switches. The metal blocks may be made of a thermally conductive metal material such as copper, aluminum or an alloy. The corresponding position here means that the projections of the metal block and the corresponding switch on the horizontal plane at least partially overlap. The lower surface 102 of the substrate is further provided with an output capacitor Co, an output terminal and an input terminal, the output capacitor Co is disposed adjacent to the third side 203 of the magnetic core, and the projection of the output capacitor Co on the horizontal plane at least partially overlaps with the projection of the lower switch on the horizontal plane. A partial of output capacitors can also be provided on the upper surface of the substrate adjacent to the lower switch according to requirements, so as to increase the capacitance value of the output capacitor and improve the dynamic performance of the system. The output terminal is disposed adjacent to the output capacitor and the lower switch, and the input terminal is disposed adjacent to the upper switch and the middle switch. The input terminal and the output terminal are placed close to the switch, which is beneficial to improving the heat dissipation of the switch.

The magnetic column of the transformer magnetic core disclosed in the present application can be integrally formed with one magnetic cover of the two magnetic covers; or each magnetic column is divided into two parts, and each part is integrally formed with one magnetic cover; and the magnetic core material of the transformer can be ferrite. The cross section of the magnetic column connected to the magnetic cover and the cross section of the magnetic cover of the magnetic core of the transformer may be rectangular, square, circular or elliptical, and are not limited thereto.

With reference to FIG. 1, the circuit topology of the present application is that two high-voltage sub-circuits are connected in series to the input middle terminal VinM; in order to solve the input voltage equalization problem of the two high-voltage sub-circuits, that is, the input voltages of the first high-voltage sub-circuit and the second high-voltage sub-circuit are equal, the present application provides a voltage equalization scheme. The circuit block diagram of the voltage equalization scheme is shown in FIG. 5, and comprises a voltage detection circuit VDC1, a voltage detection circuit VDC2, a controller, a drive circuit Dri1 and a drive circuit Dri2; the voltage detection circuit VDC1 is used for detecting the voltage between the input positive terminal Vin+ and the input middle terminal VinM (i.e., the input voltage of the first high-voltage sub-circuit), and transmitting the voltage to the controller; and the voltage detection circuit VDC2 is used for detecting the voltage between the input middle terminal VinM and the input negative terminal Vin− (i.e., the input voltage of the second high-voltage sub-circuit), and transmitting the voltage to the controller. The controller respectively receiving the input voltages of the two high-voltage sub-circuits, and adjusting the magnitude of the duty cycle of the control signals PWM1 and PWM3 or adjusting the magnitude of the duty cycle of the control signals PWM2 and PWM4, i.e., adjusting the on-time of the high-voltage switch, thereby achieving the voltage equalization of the input voltages of the two high-voltage sub-circuits. The driving circuit Dri1 receives the control signal PWM1-PWM4 and is used for driving the high-voltage circuit HC. The driving circuit Dri2 is used for receiving the control signal PWM5-8 for driving the low-voltage circuit LC. In other embodiments, the operating frequency of the control signals PWM1 and PWM3 or the operating frequency of the control signals PWM2 and PWM4 can also be controlled, i.e., the switching frequency of the high-voltage switch can be controlled, thereby achieving the voltage equalization of the input voltages of the two high-voltage sub-circuits; specifically, for a high-voltage sub-circuit with a low input voltage, the corresponding control signal or drive signal is turned off, so that the output power of the high-voltage sub-circuit decreases, so as to obtain the high-voltage sub-circuit input voltage rise; and when the input voltage of the high-voltage sub-circuit reaches a voltage equalization, the corresponding control signal or drive signal is turned on.

The switch disclosed by the application can be used for realizing the functions of the switch disclosed by the application, such as a Si MOSFET,SiC MOSFET,GaN MOSFET or IGBT MOSFET.

The power conversation device according to the embodiment can be an independent module or a part of the power supply module, and can meet the technical features and advantages disclosed by the application.

The “equal” or “same” or “equal to” disclosed by the application needs to consider the parameter distribution of engineering, and the error distribution is within +/−30%; and the included angle between the two line segments or the two straight lines is less than or equal to 45 degrees; the included angle between the two line segments or the two straight lines is within the range of [60, 120]; and the definition of the phase error phase also needs to consider the parameter distribution of the engineering, and the error distribution of the phase error degree is within +/−30%.

The embodiments in the specification are described in a progressive manner, each embodiment focuses on the difference from other embodiments, and the same similar parts between the embodiments can be referred to each other.

The above description of the disclosed embodiments enables a person skilled in the art to implement or use the present application. Various modifications to these embodiments will be readily apparent to those skilled in the art, and the generic principles defined herein may be implemented in other embodiments without departing from the spirit or scope of the application. Thus, the present application will not be limited to the embodiments shown herein but is to be accorded the widest scope consistent with the principles and novel features disclosed herein.

What is claimed is:

1. A high-power power conversion device, comprising:
a first high-voltage sub-circuit, a second high-voltage sub-circuit, a first low-voltage sub-circuit, a second low-voltage sub-circuit, an input positive terminal, an input negative terminal, an output positive terminal, and an output negative terminal,
wherein the first high-voltage sub-circuit and the second high-voltage sub-circuit are electrically connected in series between the input positive terminal and the input negative terminal, and the first low-voltage sub-circuit and the second low-voltage sub-circuit are electrically connected in parallel between the output positive terminal and the output negative terminal;
each of the first high-voltage sub-circuit and the second high-voltage sub-circuit comprises a high-voltage winding, each of the first low-voltage sub-circuit and the second low-voltage sub-circuit comprises a low-voltage winding, and the high-voltage winding and the low-voltage winding are wound on the same magnetic core;
the magnetic core comprises a first side and a third side opposite to each other, and a second side and a fourth side opposite to each other;
each of the first high-voltage sub-circuit and the second high-voltage sub-circuit comprises a plurality of high-voltage switches, and the plurality of high-voltage switches are arranged adjacent to the first side of the magnetic core; each of the first low-voltage sub-circuit and the second low-voltage sub-circuit comprises a plurality of lower switches, and the plurality of lower switches are arranged along the third side of the magnetic core.

2. The high-power power conversion device of claim 1, wherein a first end and a second end of the low-voltage winding are both disposed adjacent to the third side of the magnetic core.

3. The high-power power conversion device of claim 2, wherein the first high-voltage sub-circuit is connected between the input positive terminal and an input middle terminal, and the second high-voltage sub-circuit is connected between the input middle terminal and the input negative terminal; and a first terminal and a second terminal of the high-voltage winding are both adjacent to the first side of the magnetic core.

4. The high-power power conversion device of claim 3, wherein the second end of each high-voltage winding and the second end of each low-voltage winding have the same polarity.

5. The high-power power conversion device of claim 3, wherein the magnetic core comprises an upper magnetic cover, a lower magnetic cover and a plurality of magnetic columns, and the plurality of magnetic columns are arranged between the upper magnetic cover and the lower magnetic cover; the plurality of magnetic columns comprise a first side column, a second side column, a middle column, a first winding column, and a second winding column; the first side column, the first winding column, the middle column, the second winding column, and the second side column are arranged in the same direction in sequence.

6. The high-power power conversion device of claim 5, wherein the low-voltage winding of the first low-voltage sub-circuit is wound at least one circle around the first winding column from the first end to the second end in a first direction; and the low-voltage winding of the second low-voltage sub-circuit is wound at least one circle around the second winding column from the first end to the second end in the first direction.

7. The high-power power conversion device of claim 5, wherein the high-voltage winding of the first high-voltage sub-circuit is wound at least two circles around the first winding column from the first end to the second end in a first direction, and the high-voltage winding of the second high-voltage sub-circuit is wound at least two circles around the second winding column from the first end to the second end around the second winding column in the first direction.

8. The high-power power conversion device of claim 7, further comprising a substrate, wherein the substrate comprises an upper surface and a lower surface opposite to each other, and the substrate further comprises a plurality of wiring layers; the high-voltage winding of the first high-voltage sub-circuit from the first end to the second end is first wound at least two circles around the first winding column in the first direction on a first wiring layer, and then reaches to a second wiring layer by means of a first via and is wound at least two circles around the first winding column in the first direction on the second wiring layer; the high-voltage winding of the second high-voltage sub-circuit from the first end to the second end is first wound at least two circles around the second winding column in the first direction on the first wiring layer, and then reaches to the second layer by means of a second via and is wound at least two circles around the second winding column in the first direction on the second layer.

9. The high-power power conversion device of claim 2, wherein the plurality of lower switches of each low-voltage sub-circuit comprise a first lower switch, a second lower switch, a third lower switch, and a fourth lower switch; the first lower switch and the second lower switch are electrically connected in series to a first lower node, and are connected in series between the output positive terminal and the output negative terminal; the third lower switch and the fourth lower switch are electrically connected in series to a second lower node, and are connected in series between the output positive terminal and the output negative terminal; a first end of the low-voltage winding is electrically connected to the first lower node, and a second end of the low-voltage winding is electrically connected to the second lower node.

10. The high-power power conversion device of claim 3, wherein each of the first high-voltage sub-circuit and the second high-voltage sub-circuit comprises a switch bridge arm and a capacitor bridge arm electrically connected in parallel; the switch bridge arm is formed by electrically connecting a plurality of high-voltage switches in series, the plurality of high-voltage switches are an upper switch and a middle switch respectively, and the upper switch and the middle switch are electrically connected to a first upper node; the capacitor bridge arm comprises an upper capacitor and a middle capacitor electrically connected in series, and the upper capacitor and the middle capacitor are electrically connected in series to a second upper node; two ends of the high-voltage winding are connected across the first upper node and the second upper node of the same high-voltage sub-circuit.

11. The high-power power conversion device of claim 9, further comprising an output capacitor and an output terminal, wherein the output capacitor and the output terminal are arranged adjacent to the lower switch; the lower switches in each of the low-voltage sub-circuits are sequentially arranged along the third side of the magnetic core according to a sequence of the first lower switch, the second lower switch, the fourth lower switch, and the third lower switch.

12. The high-power power conversion device of claim 11, further comprising a substrate, wherein the substrate comprises an upper surface and a lower surface opposite to each other, at least part of the lower switches and/or at least part of the output capacitors are arranged on the upper surface, and the output terminal is arranged on the lower surface.

13. The high-power power conversion device of claim 10, further comprising a substrate, a metal block, and an input terminal, wherein the substrate comprises an upper surface and a lower surface opposite to each other, the metal block and the high-voltage switch are respectively correspondingly arranged on the upper surface and the lower surface, the input terminal is arranged adjacent to the high-voltage switch, and the upper capacitor and the middle capacitor are arranged between the high-voltage switch and the magnetic core.

14. The high-power power conversion device of claim 1, wherein the first high-voltage sub-circuit comprises a first upper switch and a first middle switch, the second high-voltage sub-circuit comprises a second upper switch and a second middle switch, and each of the first low-voltage sub-circuit and the second low-voltage sub-circuit comprises a first lower switch, a second lower switch, a third lower switch, and a fourth lower switch;
the high-power power conversion device further comprises a first control signal PWM1, a second control signal PWM2, a third control signal PWM3, a fourth control signal PWM4, a fifth control signal PWM5, a sixth control signal PWM6, a seventh control signal PWM7, and an eighth control signal PWM8;
the first upper switch is controlled by the first control signal PWM1, the first middle switch is controlled by the third control signal PWM3, the second upper switch is controlled by the second control signal PWM2, the second middle switch is controlled by the fourth control signal PWM4, and the first control signal PWM1, the second control signal PWM2, the third control signal PWM3, and the fourth control signal PWM4 are sequentially staggered by 90°;
the second lower switch and the third lower switch of the first low-voltage sub-circuit are controlled by the fifth control signal PWM5, the first lower switch and the fourth lower switch of the first low-voltage sub-circuit are controlled by the sixth control signal PWM6, the second lower switch and the third lower switch of the second low-voltage sub-circuit are controlled by the seventh control signal PWM7, the first lower switch and the fourth lower switch of the second low-voltage sub-circuit are controlled by the eighth control signal PWM8, the fifth control signal PWM5 is complementary to the first control signal PWM1, the sixth control signal PWM6 is complementary to the third control signal PWM3, the seventh control signal PWM7 is complementary to the second control signal PWM2, and the eighth control signal PWM8 is complementary to the fourth control signal PWM4.

15. The high-power power conversion device of claim 3, further comprising a controller configured to perform voltage equalization control on input voltages of the first high-voltage sub-circuit and the second high-voltage sub-circuit.

16. The high-power power conversion device of claim 15, further comprising a first voltage detection circuit, a second voltage detection circuit, a first drive circuit, and a second drive circuit, wherein the first voltage detection circuit and the second voltage detection circuit are connected to an input end of the controller, and the first drive circuit and the second drive circuit are connected to an output end of the controller;
the first voltage detection circuit is configured to detect a voltage between the input positive terminal and the input middle terminal, the second voltage detection circuit is configured to detect a voltage between the input middle terminal and the input negative terminal, the first drive circuit is configured to drive the high-voltage switch of the high-voltage sub-circuit, and the second drive circuit is configured to drive the lower switch of the low-voltage sub-circuit.

17. The high-power power conversion device of claim 16, wherein the controller adjusts a turn-on period of the high-voltage switch of the first high-voltage sub-circuit or a turn-on period of the high-voltage switch of the second high-voltage sub-circuit according to an output of the first voltage detection circuit and an output of the second voltage detection circuit, so as to achieve voltage equalization control.

18. The high-power power conversion device of claim 16, wherein the controller adjusts a switching frequency of the high-voltage switch of the first high-voltage sub-circuit or a switching frequency of the high-voltage switch of the second high-voltage sub-circuit according to an output of the first voltage detection circuit and the second voltage detection circuit, so as to achieve voltage equalization control.

19. A voltage equalization control circuit for a power conversion device, wherein the power conversion device comprises:
a first high-voltage sub-circuit, a second high-voltage sub-circuit, an input positive terminal, an input negative terminal, an input middle terminal, a low-voltage circuit, and a magnetic component, wherein the first high-voltage circuit, the second high-voltage circuit, and the low-voltage circuit are coupling and transmitting energy by means of the magnetic component;
the voltage equalization control circuit comprises a first voltage detection circuit, a second voltage detection circuit and a controller, wherein the first high-voltage sub-circuit and the second high-voltage sub-circuit are electrically connected in series between the input positive terminal and the input negative terminal, the first high-voltage sub-circuit is connected across the input positive terminal and the input middle terminal, and the second high-voltage sub-circuit is connected across the input middle terminal and the input negative terminal;
the first voltage detection circuit and the second voltage detection circuit are connected to an input end of the controller, the first voltage detection circuit is used for detecting the voltage between the input positive terminal and the input middle terminal, and the second voltage detection circuit is used for detecting the voltage between the input middle terminal and the input negative terminal;
the first high-voltage sub-circuit and the second high-voltage sub-circuit both comprise a plurality of switches, and the controller is used for performing voltage equalization control on the input voltages of the first high-voltage sub-circuit and the input voltage of the second high-voltage sub-circuit.

20. The voltage equalization control circuit for the power conversion device of claim 19, wherein the controller adjusts the on-time of the switch of the first high-voltage sub-circuit or the on-time of the switch of the second high-voltage sub-circuit according to the output of the first voltage detection circuit and the output of the second voltage detection circuit, so as to achieve voltage equalization control.

21. The voltage equalization control circuit for the power conversion device of claim 19, wherein the controller adjusts a switching frequency of the switch of the first high-voltage sub-circuit or a switching frequency of the switch of the second high-voltage sub-circuit according to an output of the first voltage detection circuit and the second voltage detection circuit, so as to achieve voltage equalization control.

22. A voltage equalization control method for a power conversion device, wherein the power conversion device comprises a first high-voltage sub-circuit, a second high-voltage sub-circuit, an input positive terminal, an input negative terminal, an input middle terminal, a low-voltage circuit, and a magnetic component, wherein the first high-voltage sub-circuit and the second high-voltage sub-circuit and the low-voltage circuit are coupling and transmitting energy by means of a magnetic component; the first high-voltage sub-circuit and the second high-voltage sub-circuit are electrically connected in series between the input positive terminal and the input negative terminal, the first high-voltage sub-circuit is connected across the input positive terminal and the input middle terminal, and the second high-voltage sub-circuit is connected across the input middle terminal and the input negative terminal; the first high-voltage sub-circuit and the second high-voltage sub-circuit both comprise a plurality of switches;
wherein the voltage equalization control method for the power conversion device comprises:
detecting an input voltage of the first high-voltage circuit and an input voltage of the second high-voltage circuit: and
adjusting a turn-on period or a switching frequency of the switch of the first high-voltage sub-circuit and/or the second high-voltage sub-circuit, so as to achieve voltage equalization control of input voltages of the first high-voltage circuit and the second high-voltage circuit.
